(19) United States
(12) Patent Application Publication
(10) Pub. No.: US 2015/0355783 A1
(43) Pub. Date: Dec. 10, 2015

(54) Control Apparatus and Control Method for Touch-Control Electronic Device

(71) Applicant: MStar Semiconductor, Inc., Hsinchu Hsien (TW)

(72) Inventors: Guo-Kiang Hung, Zhubei City (TW); Hsuan-I Pan, Zhubei City (TW); Yu-An Liang, Zhubei City (TW)

(21) Appl. No.: 14/734,166

(22) Filed: Jun. 9, 2015

(30) Foreign Application Priority Data
Jun. 10, 2014 (TW) 103120003

(51) Int. Cl. G06F 3/041

(52) U.S. Cl. CPC G06F 3/0418; G06F 3/0412

(57) ABSTRACT

A control apparatus for a touch-control electronic system is provided. The touch-control electronic system includes a display control module and a touch panel. The control apparatus includes a detecting module, a driving frequency selecting module and a driving module. The detecting module detects a synchronization frequency of an image synchronization signal that the display control module adopts. The driving frequency selecting module determines a driving frequency according to the synchronization signal. The driving module generates a driving signal having the driving frequency, and sends the driving signal to the touch panel.

This application claims the benefit of Taiwan application Serial No. 103120003, filed Jun. 10, 2014, the subject matter of which is incorporated herein by reference.

### BACKGROUND OF THE INVENTION

1. Field of the Invention

The invention relates in general to a touch system, and more particularly to a touch panel driving technology in a touch system.

2. Description of the Related Art

Operating interfaces of recent electronic products have become increasingly user-friendly and intuitive with the progressing technology. For example, through a touch screen, a user can directly interact with applications and input messages/texts/patterns with fingers or a stylus, thus eliminating complexities associated with other input devices such as a keyboard or buttons. A touch screen usually comprises a transparent sensing panel and a display panel disposed at the back of the sensing panel. According to a user touch position on the sensing panel and a currently displayed image on the display panel, an electronic apparatus determines an intention of the touch to execute corresponding operations.

For easy user portability, one development trend of portable electronic devices (e.g., mobile phones and tablet computers) is targeted at miniaturizing hardware in both weight and size. For this reason, a gap between a display panel and a touch panel in an electronic product also gets smaller and smaller. It is experimentally proven that, as a driving signal is sent out by a driver circuit of a touch panel, the driving signal may cause interference on the display panel to result ripple lines in an image that the display panel displays. Such issue is aggravated as the display panel gets closer to the touch panel.

### SUMMARY OF THE INVENTION

The invention is directed to a touch-control apparatus and a control method applied to a touch-control electronic system. By associating a frequency of a driving signal of a touch panel with a frequency of an image synchronization signal that the display panel adopts, the touch-control apparatus and control method of the present invention are capable of effectively reducing the probability of ripple lines caused by interference upon the display panel.

According to an embodiment of the present invention, a control apparatus for a touch-control electronic system is provided. The touch-control electronic system includes a display control module and a touch panel. The control apparatus includes a detecting module, a driving frequency selecting module and a driving module. The detecting module detects a synchronization frequency of an image synchronization signal that the display control module adopts. The driving frequency selecting module determines a driving frequency according to the synchronization frequency. The driving module generates a driving signal having the driving frequency, and sends the driving signal to the touch panel.

According to another embodiment of the present invention, a control method for a touch-control electronic system is provided. The touch-control electronic system includes a display control module and a touch panel. The control method includes steps of: detecting a synchronization frequency of an image synchronization signal that the display control module adopts; determining a driving frequency according to the synchronization frequency; and generating a driving signal having the driving frequency, and sending the driving signal to the touch panel.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a functional block diagram of a touch-control electronic system according to an embodiment of the present invention;

FIG. 2 is an example of a touch-control apparatus of the present invention further including a frequency band monitoring module;

FIG. 3 is an example of a touch-control apparatus of the present invention further including a position calculating module; and

FIG. 4 is a flowchart of a control method according to an embodiment of the present invention.

It should be noted that, the drawings of the present invention include functional block diagrams of multiple functional modules related to one another. These drawings are not detailed circuit diagrams, and connection lines therein are for indicating signal flows only. The interactions between the functional elements/or processes need not be achieved through direct electrical connections. Further, functions of the individual elements are not necessarily distributed as depicted, and separate blocks are not necessarily implemented by separate electronic elements.

### DETAILED DESCRIPTION OF THE INVENTION

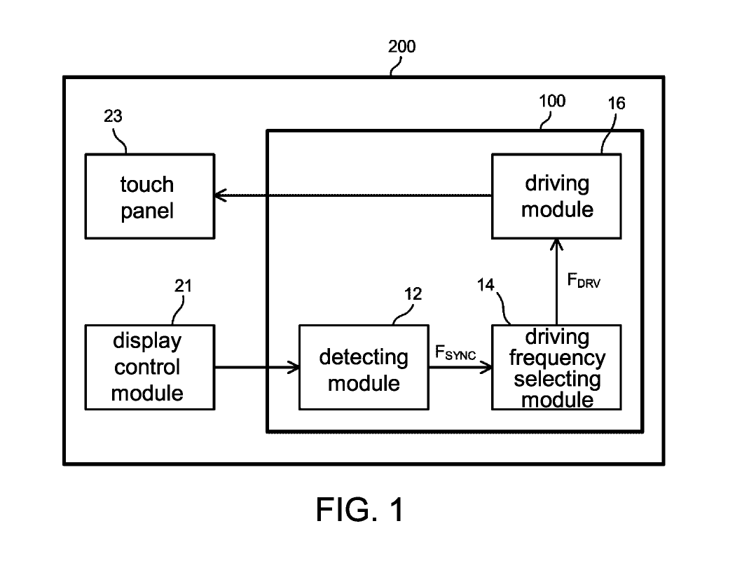

FIG. 1 shows a functional block diagram of a touch-control apparatus for a touch-control electronic system according to an embodiment of the present invention. A touch-control electronic apparatus 200 includes a display control module 21, a touch panel 23 and a touch-control apparatus 100. The touch-control apparatus 100 includes a detecting module 12, a driving frequency selecting module 14 and a driving module 16. In practice, the touch-control apparatus 100 may be integrated in the touch-control electronic system 200, or may be an independent unit outside the touch-control electronic system 200. For example, the touch panel 23 may be a self-capacitive or mutual-capacitive touch panel.

The detecting module 12 detects a frequency F_{SYNC} (to be referred to as a synchronization frequency) of an image synchronization signal that the display control module 21 adopts. In practice, the image synchronization signal may be a horizontal synchronization signal or a vertical synchronization signal. The horizontal synchronization signal is usually used to indicate a starting position of one horizontal image line in an image frame/field, and a vertical synchronization signal is usually used to indicate a starting position of one image frame/field. In one embodiment, the detecting module 12 simultaneously receives a horizontal synchronization signal and a vertical synchronization signal that the display control module 21 adopts, respectively detects the frequencies of these two signals and selects one of the two frequencies as the synchronization frequency F_{SYNC}.

The driving frequency selecting module 14 selects a driving frequency F_{DRV} according to the synchronization frequency F_{SYNC}. And the driving module 16 sends the driving signal to the touch panel 23. The frequency of the driving signal is the driving frequency F_{SYNC}. In one embodiment, the driving frequency selecting module 14 causes the driving frequency F_{DRV} to be an integral multiple or a fractional multiple of the synchronization frequency F_{SYNC}. In practice, the driving signal provided to the touch panel 23 may have an appropriate frequency range (associated with the sensing method and specifications of the touch panel 23). From this range, the driving frequency selecting module 14 may select a particular integral multiple or fractional multiple of the synchronization frequency F_{SYNC} as the driving frequency F_{DRV}.

In one embodiment, when selecting the driving frequency F_{DRV}, the driving frequency selecting module 14 further considers a current operating mode of the touch-control electronic system 200. For example, when the touch-control electronic system 200 is in a standby mode and is not required to provide accurate touch sensing results, the driving frequency selecting module 14 may select a lower driving frequency F_{DRV}, or may select a smaller integral multiple or fractional multiple value to reduce the power consumption of the driving module 16. In contrast, when the touch-control electronic system 200 is currently executing an application that requires accurate sensing results, the driving frequency selecting module 14 may select a higher driving frequency F_{DRV}.

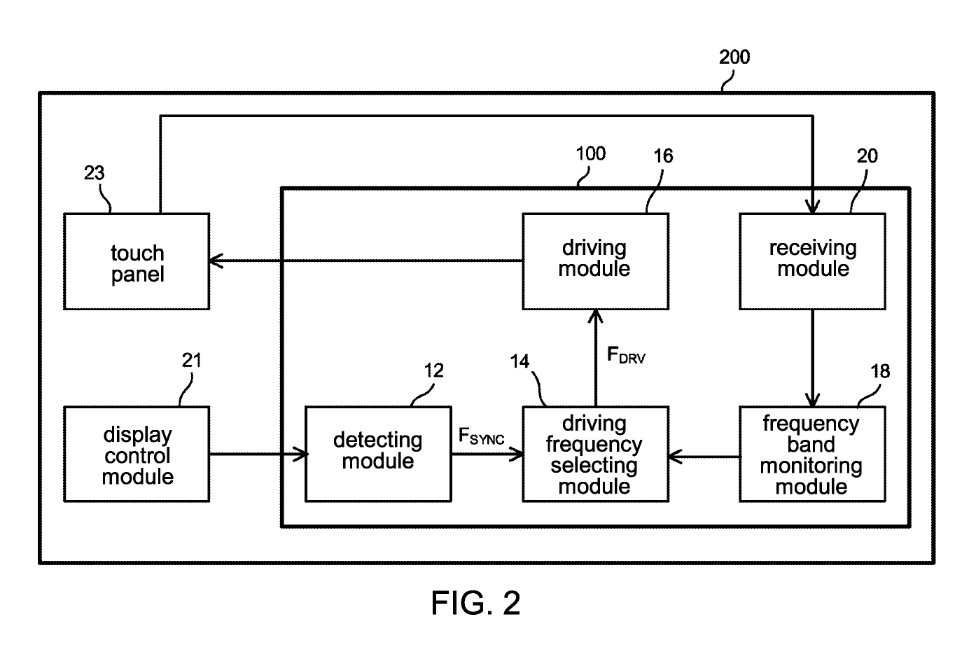

Referring to FIG. 2, the touch-control apparatus 100 may further include a frequency band monitoring module 18 and a receiving module 20. When the driving module 16 sends a driving signal to the touch panel 23, the receiving module 20 receives a touch sensing signal from the touch panel 23 for calculating a touch position and monitoring noises. For example, when a finger touches a screen, a minute amount change occurs in the sensing signals. Such amount change is received by the receiving module 20, amplified, demodulated by a digital circuit (not shown), and processed by a rear-end calculation circuit to finally calculate an actual touch position. When a noise monitoring mode is turned on, the driving module 16 does not send out a driving signal (or send out a direct-current signal), and the signal received by the receiving module 20 at this point is a noise signal. This noise signal first undergoes digital signal processing and is then sent to the frequency band monitoring module 18. The frequency band monitoring module 18 monitors an environmental interference status, and selects a usable frequency band having lower interference from a plurality of candidate frequency bands according to the noise signal. For example, the frequency band monitoring module 18 performs Fourier analysis on the noise signal to obtain a spectrum distribution of the noise. At this point, the driving frequency selecting module 14 may select a flatter frequency (a noise-free frequency band) as the driving signal frequency—such technique is referred to as frequency hopping. Finally, the driving frequency selecting module 14 then selects an integral multiple or a fractional multiple of the synchronization frequency F_{SYNC} as the driving frequency F_{DRV} located in one of the usable frequency bands. That is to say, in addition to the synchronization frequency F_{SYNC}, the driving frequency selecting module 14 also considers whether a cleaner, noise-free driving signal can be provided to the touch panel 23. For example, assuming that the horizontal synchronization signal is F_{HSYNC} and the driving frequency is F_{C}, the driving frequency selecting module 14 determines a frequency multiplier factor N according to a ratio of F_{C} to F_{HYSNC}, with an equation represented as F_{HSYNC}*N=F_{C}. Assuming that the vertical synchronization frequency is 60 Hz and the display has 1000 vertical lines, the horizontal synchronization signal is 601 000=60 KHz. Assuming that after the noise detection, the frequency band monitoring module 18 deems that 110 KHz to 120 KHz may be a low-noise frequency band. At this point, the driving frequency selecting module 14 may select 110 KHz to be the driving frequency, and N is a fractional multiple 11/6. Alternatively, the driving frequency selecting module 14 may select 120 KHz to be the driving frequency, and N is an integral multiple 2.

In practice, the driving frequency selecting module 14 may be implemented by a fixed and/or programmable digital logic circuit, and includes a programmable logic gate array, an application-specific integrated circuit, a microcontroller, a microprocessor, a digital signal processor and other necessary circuits. Further, the driving frequency selecting module 14 may also be designed to complete its task through executing a processor instruction stored in a memory.

In another embodiment, in addition to providing the driving signal having a frequency associated with the synchronization frequency F_{SYNC}, the driving module 16 further causes a rising edge or a falling edge of the driving signal to be aligned with a rising edge or a falling edge of the image synchronization signal. It should be noted that, technologies of generating a driving signal for a touch panel according to a specific frequency are generally known to one person skilled in the art, and shall be omitted herein.

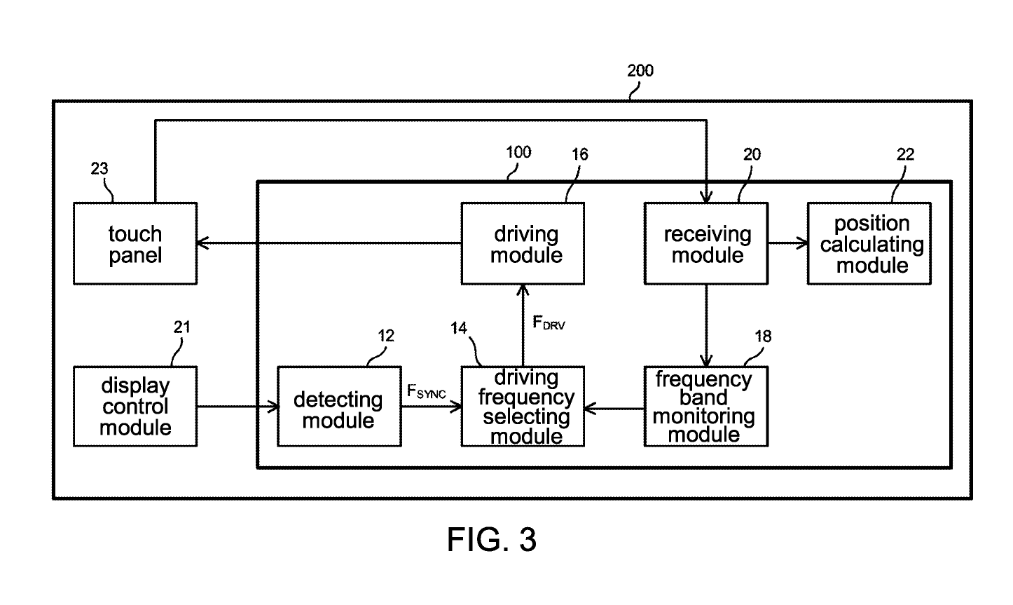

The scope of the present invention is not limited to implementing the touch-control apparatus 100 with a certain configuration or architecture. One person skilled in the art can understand that, there are other circuit configurations and elements that can implement the concept of the present invention without departing from the spirit of the present invention. Further, as shown in FIG. 3, apart from the foregoing circuit functional blocks, the touch-control apparatus 100 may further include a position calculating module 22 for analyzing a sensing capacitance difference to calculate a touch position.

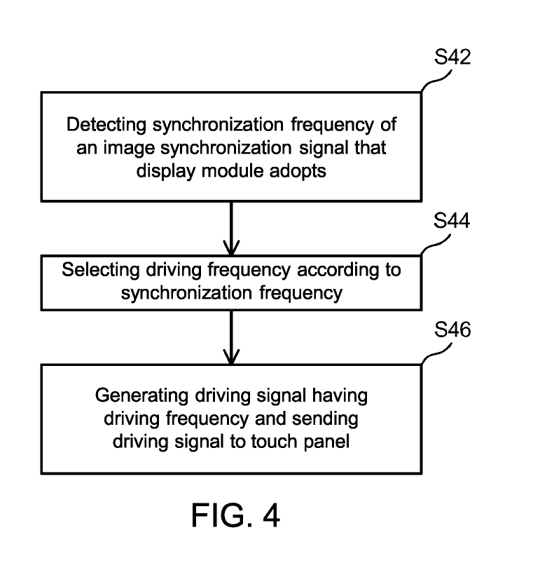

FIG. 4 shows a flowchart of a control method for a touch-control electronic system according to another embodiment of the present invention. The touch-control electronic system includes a display control module, a touch panel and a touch module. The control method includes following steps. In step S42, a synchronization frequency of an image synchronization signal that the display control module adopts is detected. In step S44, according to the synchronization frequency, a driving frequency is selected. In step S46, a driving signal having the driving frequency is generated, and the driving signal is sent to the touch panel. One person skilled in the art can understand that the variations disclosed in the description associated with the touch-control apparatus 100 (e.g., the factors considered when selecting the driving frequency) are also applicable to the control method in FIG. 3, and shall be omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch-control apparatus for a touch-control electronic system, the touch-control electronic system comprising a display control module and a touch panel, the touch-control apparatus comprising:
a detecting module, configured to detect a synchronization frequency of an image synchronization signal that the display control module adopts;
a driving frequency selecting module, configured to determine a driving frequency according to the synchronization frequency; and
a driving module, configured to generate a driving signal having the driving frequency, and to send the driving signal to the touch panel.

2. The touch-control apparatus according to claim 1, wherein the image synchronization signal is one of a horizontal synchronization signal and a vertical synchronization signal.

3. The touch-control apparatus according to claim 1, wherein the driving frequency selecting module causes the driving frequency to be one of an integral multiple and a fractional multiple of the synchronization frequency.

4. The touch-control apparatus according to claim 1, further comprising:
a receiving module, configured to receive a touch sensing signal from the touch panel; and
a frequency band monitoring module, configured to monitor an environmental interference status according to the touch sensing signal, and to accordingly select at least one usable frequency band having lower interference from a plurality of candidate frequency bands;
wherein, the driving frequency selecting module selects the driving frequency located in the at least one usable frequency band.

5. The touch-control apparatus according to claim 1, wherein the driving frequency selecting module further considers a current operating mode of the touch-control electronic system when selecting the driving frequency.

6. The touch-control apparatus according to claim 1, wherein the driving module causes a rising edge or a falling edge of the driving signal to be aligned with a rising edge or a falling edge of the image synchronization signal.

7. A control method for a touch-control electronic apparatus, the touch-control electronic apparatus comprising a display control module and a touch panel, the control method comprising:
a) detecting a synchronization frequency of an image synchronization signal that the display control module adopts;
b) determining a driving frequency according to the synchronization frequency; and
c) generating a driving signal having the driving frequency, and sending the driving signal to the touch panel.

8. The control method according to claim 7, wherein the image synchronization signal is one of a horizontal synchronization signal and a vertical synchronization signal.

9. The control method according to claim 7, wherein the driving frequency is one of an integral multiple and a fractional multiple of the synchronization frequency.

10. The control method according to claim 7, further comprising:
receiving a touch sensing signal from the touch panel; and
monitoring an environmental interference status according to the touch sensing signal, and accordingly selecting at least one usable frequency band having lower interference from a plurality of candidate frequency bands;
wherein, step (b) comprises selecting the driving frequency located in the at least one usable frequency band.

11. The control method according to claim 7, wherein step (b) comprises:
further considering a current operating mode of the touch-control electronic system when selecting the driving frequency.

12. The control method according to claim 7, wherein step (c) comprises:
causing a rising edge or a falling edge of the driving signal to be aligned with a rising edge or a falling edge of the image synchronization signal.
